(19) United States
(12) Patent Application Publication
(10) Pub. No.: US 2012/0006062 A1
(43) Pub. Date: Jan. 12, 2012

(54) APPARATUS FOR MANUFACTURING GLASS MOLDING

(76) Inventor: Wataru Nakagawa, Hyogo (JP)

(21) Appl. No.: 13/258,261

(22) PCT Filed: Mar. 4, 2010
(86) PCT No.: PCT/JP2010/053537

§ 371 Date: Sep. 21, 2011

(30) Foreign Application Priority Data
Apr. 24, 2009 (JP) 2009-106293

(51) Int. Cl. C03B 11/06; C03B 11/00

(52) U.S. Cl. 65/66; 65/305

(57) ABSTRACT

Provided is an apparatus for manufacturing a glass molding which can manufacture a glass molding having a high precision optical surface. An apparatus for manufacturing a glass molding has a lower die which receives molten glass, and an upper die which conducts pressure molding of the molten glass supplied to the lower die in conjunction therewith, wherein the upper die has a first molding surface which transfers the optical surface, a second flat molding surface provided around the periphery of the first molding surface, and a third molding surface provided around the periphery of the second molding surface and tilting relative to the central axis of the upper die passing through the center of the first molding surface to spread in the direction of the lower die.

### FIELD OF THE INVENTION

The present invention relates to an apparatus for manufacturing a glass molding, particularly to an apparatus for manufacturing a glass molding, which produces a glass molding by pressure-molding of molten glass with molding dies.

### BACKGROUND ART

A glass-made optical element has come to be employed as a lens for a digital camera, an optical pickup lens of a DVD and others, a camera lens for a mobile phone, a coupling lens for optical communications, and various types of mirrors, and its range of use is ever expanding. Such a glass optical element is often produced by a press molding method in recent years in which molding dies are used for pressure-molding of a glass material. Especially when manufacturing an optical element having an aspherical surface as an optical surface, it is becoming a common practice to use a press molding method by molding dies, because surface formation by grinding and polishing is not easy. Above all, the attention of the industry is focused on the direct pressing method for its high production efficiency, wherein a glass-made optical element is produced directly by pressure-molding of molten glass by the molding dies.

In one of the techniques known in the conventional art for getting directly a glass-made optical element by pressure-molding of molten glass directly by molding dies, molten glass fed from the nozzle edge is made to reside in the lower die, and the molten glass in the lower die is subjected to pressure molding by the upper and lower dies (refer to Patent Literature 1).

In the method wherein the molten glass is directly subjected to pressure molding by the molding dies as disclosed in the Patent Literature 1, the molten glass having a higher temperature than the molding dies is supplied to the molding dies, and the supplied molten glass is solidified by being cooled mainly by the discharge of heat from the surface in contact with the molding dies.

However, in the process of molding, the molten glass cooling speed is different between the upper and lower surfaces of the molten glass or between the central and peripheral portions of it. Thus, uneven shrinkage is caused by cooling. Accordingly, especially it has been very difficult to form a high-precision optical surface on the lower side of the molten glass which is subjected to rapid cooling by coming in contact with the lower die first.

The Patent Literature 1 proposes a method for manufacturing a glass lens. According to this proposed method, only the optical surface on the upper side where the temperature of the molten glass is relatively stable is formed by the transfer of the molding surface of the upper die. After the glass molding has been formed, the optical surface on the lower side is formed by additional machining (grinding and polishing).

### PRIOR ART LITERATURE

### Patent Literature

Patent Literature 1: Japanese Unexamined Patent Application Publication No. 2008-230874

### SUMMARY OF THE INVENTION

### Problems to be Solved by the Invention

Incidentally, in the glass molding formed by the method where the molten glass is directly subjected to pressure molding by the molding dies as disclosed in the Patent Literature 1, since transferability is poor on the optical surface on the lower side, additional machining is required to make up this defect. Thus, a reference surface required for additional machining is formed in the molding process.

Referring to FIGS. 4, 5a and 5b, the following describes the conventionally known typical method for forming a reference surface. FIG. 4 is a schematic cross sectional view showing an overall structure as an example of the conventional molding die. FIGS. 5a and 5b are schematic cross sectional views showing an overall structure as another example of the conventional molding die.

1. A method for providing an upper die 10, for example, with a cylindrical molding surface 10k for regulating the outer diameter of the side of the glass molding, and forming an even reference surface on the side of the glass molding, by means of this molding surface 10k, as shown in FIG. 4.

2. A method for providing a flat molding surface 10h, for example, on the periphery of the aspherical molding surface 10a of the upper die 10 provided with the aspherical molding surface 10a, and forming a flat reference surface on the periphery of the upper surface of the glass molding, by means of this flat molding surface 10h, as shown in FIGS. 5a and 5b.

However, in the pressure application step of the aforementioned method 1, there is a difference in the spreading speed of the periphery of the molten glass 80 stored on the receiving surface 20a of the lower die 20, depending on the location. For example, the portion A is brought in contact with the molding surface 10k earlier than the portion B, and is subjected to rapid cooling. To be more specific, there is a big difference in the cooling speed between the portion A and B of the molten glass 80. This results in uneven shrinkage of the molten glass 80 during the molding process. It has been difficult in the conventional art to form a high-precision optical surface on the upper side of the glass molding.

Further, in the method described in the aforementioned method 2, the molten glass 80 stored on the receiving surface 20a of the lower die 20 fails to spread out uniformly in the pressurizing process. A shown in FIG. 5b, the portion A, for example, may extend over the molding surface 10h deeply in some cases. This results in uneven shrinkage of the molten glass 80 during the molding process, similarly to the case of the aforementioned method 1. Thus, it has been difficult in the conventional art to form a high-precision optical surface on the upper side of the glass molding.

In view of the problems described above, it is an object of the present invention to provide an apparatus for manufacturing a glass molding, which can manufacture glass molding having a high-precision optical surface.

### Means for Solving the Problems

The above objects can be achieved by any one of the following items 1 to 3 of the invention:

1. An apparatus for manufacturing a glass molding, the apparatus including:

a lower die for receiving molten glass; and

an upper die for conducting pressure-molding of the molten glass supplied to the lower die, in conjunction with the lower die,

wherein the upper die includes:

a first molding surface which transfers an optical surface;

a second molding surface which is flat and provided on a periphery of the first molding surface; and

a third molding surface which is provided on a periphery of the second molding surface and tilts relative to a central axis of the upper die, which passes through a center of the first molding surface so that the third molding surface spreads in a direction toward the lower die.

2. The apparatus for manufacturing a glass molding of abovementioned item 1,

wherein a tilt angle of the third molding surface relative to the central axis meets a following conditional expression (1):

10°<θ<60° (1)

wherein

θ: The tilt angle of the third molding surface relative to the central axis of the upper die.

3. The apparatus for manufacturing a glass molding of the abovementioned item 1 or 2, wherein a dimension of the third molding surface in a direction of the central axis, and a dimension of a side surface of the glass molding in the direction of the central axis meet a following conditional expression (2), with the side surface including a transfer surface formed by the third molding surface:

0.1<d/D<0.7 (2)

wherein

d: The dimension of the third molding surface in the direction of the central axis

D: The dimension of the side surface of the glass molding in the direction of the central axis, with the side surface including the transfer surface formed by the third molding surface.

### EFFECTS OF THE INVENTION

According to the present invention, a second flat molding surface is provided on the periphery of the first molding surface which transfers the optical surface of the upper die, and a third molding surface is provided on the periphery of the second molding surface in such a way as to tilt relative to the central axis of the upper die passing through the center of the first molding surface so as to spread in the direction toward the lower die. To be more specific, the periphery of the first molding die is provided with a molding surface so that the cross section of the molding surface formed by the second molding surface and third molding surface is V-shaped.

This V-shaped molding surface minimizes the unwanted spreading of the molten glass stored on the receiving surface of the lower die toward the periphery and ensures uniform spreading during the pressurizing process. This arrangement minimizes differences in the cooling speed depending on the particular spot of the molten glass, and ensures uniform shrinkage of the molten glass in the molding process, with the result that high-precision optical surface is formed on the upper surface of the glass molding.

### BRIEF DESCRIPTION OF THE DRAWINGS

FIG. 1 is a schematic cross sectional view showing the overall structure of an apparatus for manufacturing a glass molding in an embodiment of the present invention.

FIGS. 2a and 2b are schematic cross sectional views showing the overall structure of molding dies in an embodiment of the present invention.

FIGS. 3a and 3b are schematic cross sectional views showing examples of a glass molding and aspherical lens in an embodiment of the present invention.

FIG. 4 is a schematic cross sectional view showing an overall structure as an example of the conventional molding die.

FIGS. 5a and 5b are schematic cross sectional views showing an overall structure as another example of the conventional molding die.

### DESCRIPTION OF EMBODIMENTS FOR CARRYING OUT THE INVENTION

The following describes the embodiments of the apparatus for manufacturing a glass molding in the present invention with reference to accompanying drawings. It should be noted, however, that the present invention is not restricted to the embodiments to be described below even though description will be made based on the embodiments in the drawings.

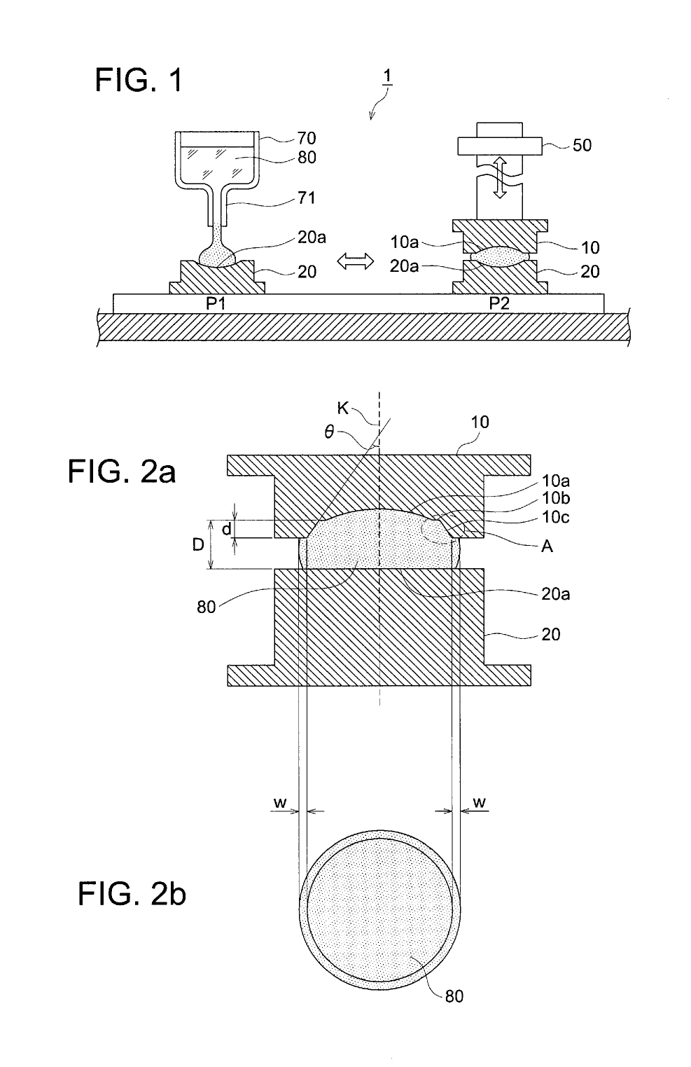

In the first place, the following describes the overall structure of an apparatus for manufacturing a glass molding in the present invention referring to FIG. 1. FIG. 1 is a schematic cross sectional view showing the overall structure of a glass molding manufacturing apparatus 1. The left sketch of FIG. 1 illustrates the molten glass supply process, and the right sketch shows the pressurizing process.

The glass molding manufacturing apparatus 1 includes a melting reservoir 70, upper die 10, lower die 20 and pressurizing section 50.

The lower die 20 can be moved by a driving unit (not illustrated) between the position P1 for receiving the molten glass 80 below a nozzle 71 and the position P2 for pressure-molding of the molten glass 80 where the upper die 10 is opposed.

The melting reservoir 70 melts the glass material supplied inside and generates molten glass 80. A nozzle 71 is installed below the melting reservoir 70. The molten glass 80 is supplied from the nozzle 71 to a receiving surface 20a of the lower die 20. An agitating blade (not illustrated) is provided inside the melting reservoir 70. This agitating blade is turned to agitate and homogenize the molten glass 80.

Platinum, for example, can be used as a material of the melting reservoir 70, nozzle 71 and agitating blade. Outside the melting reservoir 70, a refractory reinforcement member can be provided to support the entire melting reservoir 70. Heaters and temperature sensors (not illustrated) are installed around the melting reservoir 70 and nozzle 71 to control the heating temperature to a prescribed level, respectively.

The molding dies are made of an upper die 10 and lower die 20. The upper die 10 is provided with a concave aspherical molding surface 10a for forming an optical surface of the glass molding. Further, the periphery of the molding surface 10a is provided with a molding surface (to be described later) for minimizing the unwanted spreading of the molten glass stored on the receiving surface 20a of the lower die 10 toward the periphery, during the pressurizing process. A flat-surface-shaped receiving surface 20a for receiving the molten glass 80 is formed on the lower die 20.

In the present embodiment, the molding surface 10a of the upper die 10 is formed as a concave aspherical surface, but can be a convex aspherical or spherical surface. Further, the receiving surface 20a of the lower die 20 is formed as a flat surface, but can be a concave surface.

The upper die 10 and lower die 20 have heaters and temperature sensors (not illustrated) to control the heating temperature to a prescribed level, respectively.

The heaters and temperature sensors can be designed to control the temperature of each member independently. One or a plurality of heaters can be configured to heat the entire molding dies collectively. The heater can be selected from among various types of commonly known heaters, as appropriate. For example, it is possible to use a cartridge heater embedded in a member, a sheet-shaped heater used in contact with the outside of the member, an infrared heater and a high-frequency induction heater. The temperature sensor can be a commonly known sensor selected from among various types of thermocouples, platinum resistance temperature sensors and various types of thermistors.

In the molding dies, the heating temperature of the upper die 10 must be set within the temperature range capable of ensuring faithful transfer of the profile of the molding surface 10a onto the molten glass 80. Normally, the preferred temperature is within the range of Tg (glass transition point) of the glass to be formed −100 degrees Celsius through Tg+100 degrees Celsius. Insufficient heating temperature cannot ensure faithful transfer of the profile of the molding surface 10a to the molten glass 80. Excessive heating temperature should be avoided to prevent fusion between the molten glass 80 and molding dies, or to prolong the service life of the molding dies. An appropriate temperature should be determined with consideration given to various conditions including the material of the glass to be molded, the profile and size of the glass molding, the material of the molding dies, type of the protective film, and the positions of the heaters and temperature sensors.

Unlike the case of the upper die 10, the heating temperature of the lower die 20 does not required consideration to be given to the transferability of the receiving surface 20a. However, to avoid adverse effect on the cooling speed of the molten glass 80, the preferred temperature is within the range of Tg of the glass to be formed −100 degrees Celsius through Tg+100 degrees Celsius, similarly to the case of the upper die 10.

The upper die 10 and lower die 20 can be made of the material selected from among the commonly known materials for the molding dies for pressure molding of the glass molding, as exemplified by cemented carbide material having tungsten carbide as a major component, silicon carbide, silicon nitride, aluminum nitride and carbon. Further, a protective film made of various types of metal, ceramic or carbon can be formed on the surface of such a material. The upper die 10 and lower die 20 can be made of the same material or different materials.

The commonly known pressure mechanism such as a pneumatic cylinder, hydraulic cylinder or electric power driven cylinder using a servo motor can be used as the mechanism of the pressuring section 50. The pressuring section 50 drives the upper die 10, whereby the molten glass 80 is subjected to pressure-molding. In the present embodiment, the pressurizing section 50 is designed to drive the upper die 10. Without being restricted thereto, it is also possible to arrange such a configuration that the lower die 20 or both the upper die 10 and lower die 20 are driven.

Without being restricted to any particular material, the glass material can be selected from among the conventionally known glasses for optical application, as appropriate. The examples include phosphoric acid-based and lanthanum-based glasses.

Referring to FIG. 1, the following describes the overview of the method of manufacturing the glass molding using the glass molding manufacturing apparatus 1.

In the present embodiment, from the nozzle 71 located below the melting reservoir 70, the molten glass 80 is supplied to the receiving surface 20a of the lower die 20 of the molding dies heated to a prescribed temperature lower than that of the molten glass 80 (molten glass supply process). In this case, the melting reservoir 70 and nozzle 71 have been heated to prescribed respective temperatures by a heater (not illustrated). The lower die 20 supplied with the molten glass 80 moves below the upper die 10, and the molten glass 80 is subject to pressure-molding by the lower die 20 and upper die 10, thereby producing a glass molding on which respective molding surfaces (molding surface 10a and receiving surface 20a) have been transferred (pressurizing process).

In the glass molding manufacturing apparatus 1 of the aforementioned structure, the present invention is characterized by a pressurizing process wherein the molding surface for minimizing unwanted spreading of the molten glass 80 stored on the receiving surface 20a of the lower die 10 toward the periphery is formed on the periphery of the aspherical molding surface 10a of the upper die 10. Referring to FIGS. 2a and 2b, the following describes the details. FIG. 2a is a schematic cross sectional view showing the overall structure of molding dies. FIG. 2b is a schematic plan view showing the spreading of molten glass 80 during the molding process.

As shown in FIG. 2a, the aspherical molding surface 10a (first molding surface) is formed on the upper die 10, and a flat-surface-shaped molding surface 10b (second molding surface) is formed on the periphery of the molding surface 10a. The molding surface 10b is a flat surface perpendicular to the optical axis K (central axis of the upper die 10) of the aspherical surface formed by the molding surface 10a. Further, a molding surface 10c (third molding surface) tilted relative to the optical axis K so as to spread toward the lower die 20 is formed on the periphery of the molding surface 10b. A flat receiving surface 20a for receiving the molten glass 80 is formed on the lower die 20.

In the present embodiment, the molding surface 10a of the upper die 10 is formed in a concave aspherical shape. As described above, the molding surface 10a can be formed in a convex aspherical or spherical shape. Further, the receiving surface 20a of the lower die 20 is designed to have a flat surface, but can be designed to have a concave or convex shape.

In the molding dies of such a structure, in the pressurizing process, the molten glass 80 stored on the receiving surface 20a of the lower die 10 is protected from unwanted spreading to the peripheral area, by the V-shaped molding surface formed of molding surfaces 10b and 10c, as shown by portion A in FIG. 2a. Further, uniform spreading of the molten glass 80 to the periphery is ensured, as shown in FIG. 2b. This arrangement minimizes the differences in the cooling speed due to the different spots of the molten glass 80, and ensures a uniform shrinkage of the molten glass 80 at the time of molding operation, with the result that a high-precision optical surface is formed on the upper side of the glass molding 100.

The angle of inclination of the molding surface 10c (third molding surface) of the upper die 10 relative to the optical axis K (central axis of upper die 10) preferably meets the following conditional expression (1):

10°<θ<60° (1)

wherein

θ: Angle of inclination of molding surface 10c relative to the optical axis K

If the angle of inclination is below the lower limit of the conditional expression (1) and the inclination of the molding surface 10c is too steep, the molten glass 80 on the receiving surface 20a of the lower die 20 is prevented by the molding surface 10c from spreading, and is cooled and solidified. This prevents the flat surface portion in the surroundings from being formed and raises problems in the secondary processing. By contrast, if the angle of inclination exceeds the upper limit of the conditional expression (1) and the inclination of the molding surface 10c is too gradual, there will be unwanted spreading of the molten glass 80 stored on the receiving surface 20a of the lower die 20 toward the periphery, and uniform spreading on the periphery will be prevented. This will cause astigmatism to be produced. Thus, if the expression (1) is satisfied, unwanted spreading of the molten glass 80 to the periphery can be minimized, without the spreading of the molten glass 80 from being interrupted. This arrangement ensures a high-precision transfer surface 100a (optical surface) to be formed on the upper side of the glass molding 100.

The dimension of the molding surface 10e (third molding surface) in the direction of the optical axis K (central axis of upper die 10) and dimension of the side surface in the direction of the central axis K, including the transfer surface 100c of the glass molding 100, formed by the molding surface 10c preferably meet the following conditional expression (2):

0.1<d/D<0.7 (2)

wherein

d: Dimension of the molding surface 10c in the direction of central axis K

D: Dimension of the side surface in the direction of the central axis K, including the transfer surface 100c of the glass molding 100, formed by the third molding surface 10c

If the dimension is below the lower limit of the conditional expression (2) and the height of the molding surface 10c is insufficient, there will be unwanted spreading of the molten glass 80 stored on the receiving surface 20a of the lower die 20 toward the periphery, and uniform spreading on the periphery will be prevented. This will cause astigmatism to be produced. If the height of the molding surface 10c is excessive, the molten glass 80 on the receiving surface 20a of the lower die 20 is prevented by the molding surface 10e from spreading, and is cooled and solidified. This prevents the flat surface portion in the surroundings from being formed and raises problems in the secondary processing. Thus, similarly to the case of the expression (1), if the expression (2) is satisfied, unwanted spreading of the molten glass to the periphery can be minimized, without the spreading of the molten glass 80 from being interrupted. This arrangement ensures a high-precision transfer surface 100a (optical surface) to be formed on the upper side of the glass molding 100.

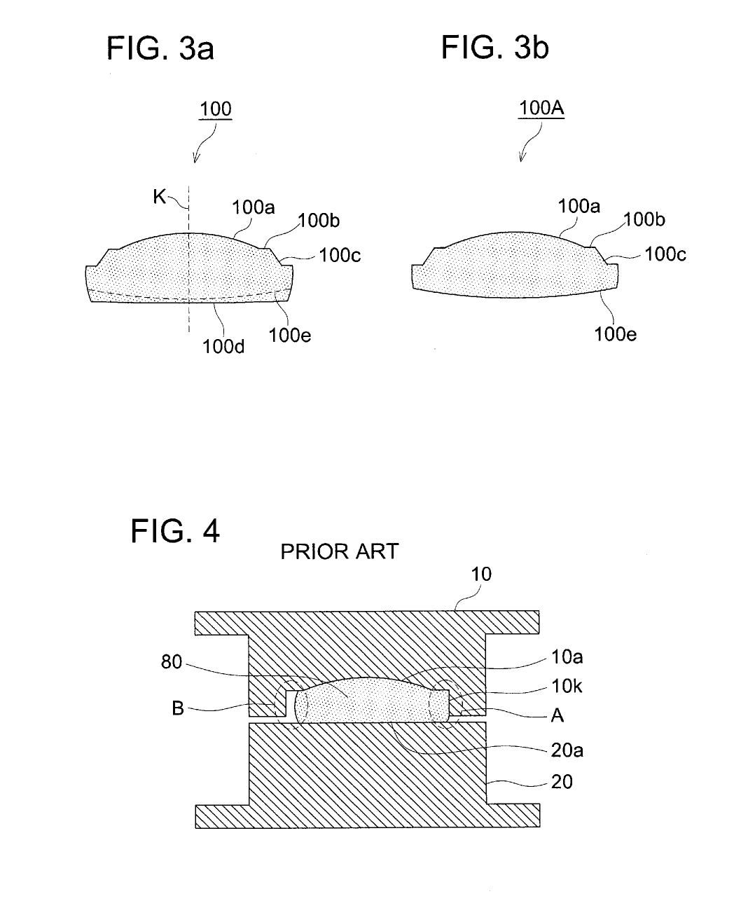

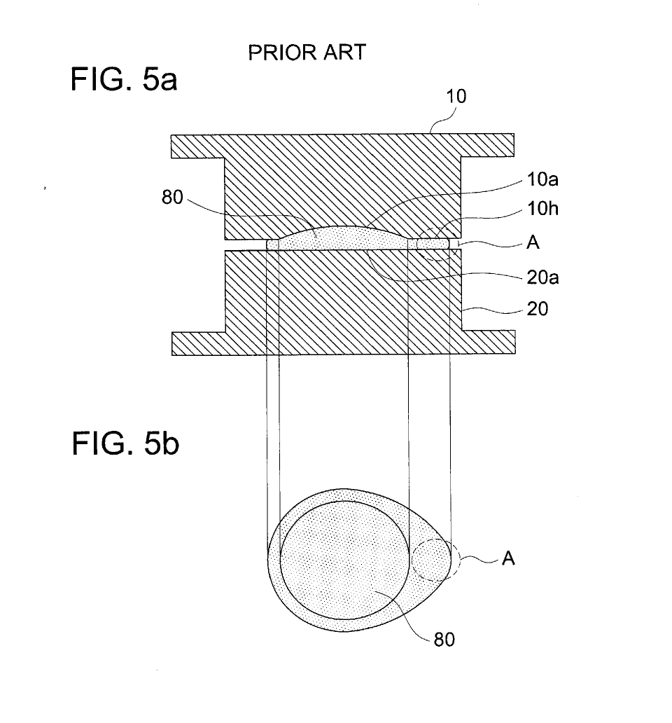

Referring to FIGS. 3a and 3b, the following describes the glass molding formed by the glass molding manufacturing apparatus 1 characterized by the aforementioned structure. FIG. 3a is a schematic cross sectional view showing an example of a glass molding 100.

As shown in FIG. 3a, a convex aspherical transfer surface 100a (optical surface) is formed on one surface of the glass molding 100 by the upper die 10, and a flat-surface-shaped transfer surface 100b is formed on the periphery of the transfer surface 100a. Further, the transfer surface 100c tilting relative to the optical axis K so as to spread downward is formed on the periphery of the transfer surface 100b. A flat transfer surface 100d is formed on the other surface by the lower die 20. Because of poor transferability, the transfer surface 100d formed by the lower die 20 will be finished, for example, to a high-precision convex spherical surface (machined surface 100e) as shown by the broken line, in the machining process of the later processes. The flat-surface-shaped transfer surface 100b can be used as the reference surface for the machining.

FIG. 3b shows an example of the aspherical lens 100A finished in the aforementioned procedure. As shown in FIG. 3b, the convex aspherical transfer surface 100a (optical surface) is formed by pressure molding on one surface of the aspherical lens 100A. A convex spherical machined surface 100e (optical surface) is formed on the other surface by machining. In this embodiment, the machine surface 100e is formed into a convex shape, but can be formed in a concave shape, without any particular restriction to the shape.

The optical surface can be formed by such a machining process as a coarse polishing process using a high-speed grinder (curve generator) or the like, a fine-grinding process using a diamond pellet and others, or a polishing process for finishing the surface with polishing agent. Without being restricted thereto, a conventionally known method can be used as appropriate. It is also possible to add a step of forming an edge of the aspherical lens 100A by grinding or others.

In the glass molding manufacturing apparatus 1 in an embodiment of the present invention, a flat-surface-shaped molding surface 10b (second molding surface) is formed on the periphery of the aspherical molding surface 10a (first molding surface) of the upper die 10, and a molding surface 10c (third molding surface) is provided on the periphery of the second molding surface in such a way as to tilt relative to the central axis (optical axis K) of the upper die 10 passing through the vertex of the first molding surface so as to spread in the direction toward the lower die 20. To be more specific, a molding surface having a V-shaped cross section formed by the second molding surface and third molding surface is provided on the periphery of the first molding surface.

The aforementioned V-shaped molding surface minimizes unwanted spreading of the molten glass 80 stored on the receiving surface 20a of the lower die 20 toward the periphery, and ensures uniform spreading of the molten glass. This arrangement minimizes the differences in the cooling speed due to the different positions of the molten glass 10, and ensures a uniform shrinkage of the molten glass 80 at the time of molding operation, with the result that a high-precision transfer surface 100a (optical surface) is formed on the surface of the upper side of the glass molding 100.

### DESCRIPTION OF REFERENCE NUMERALS

1. Glass molding manufacturing apparatus

10. Upper die

10a, 10b, 10c. Molding surfaces (first, second and third molding surfaces)

10h. Molding surface

10k. Molding surface

20. Lower die

20a. Receiving surface

50. Pressurizing section

70. Melting reservoir

71. Nozzle

80. Molten glass

100. Glass molding

100a. Transfer surface (aspherical surface)

100b. Transfer surface

100c. Transfer surface

100d. Transfer surface (flat surface)

100e. Machined surface

100A. Aspherical lens

K. Optical axis

1. An apparatus for manufacturing a glass molding, the apparatus comprising:
a lower die for receiving molten glass; and
an upper die for conducting pressure-molding of the molten glass supplied to the lower die, in conjunction with the lower die,
wherein the upper die comprises:
a first molding surface which transfers an optical surface;
a second molding surface which is flat and provided on a periphery of the first molding surface; and
a third molding surface which is provided on a periphery of the second molding surface and tilts relative to a central axis of the upper die, which passes through a center of the first molding surface so that the third molding surface spreads in a direction toward the lower die.

2. The apparatus for manufacturing a glass molding of claim 1,
wherein a tilt angle of the third molding surface relative to the central axis meets a following conditional expression (1):
10°<θ<60° (1)
wherein
θ: The tilt angle of the third molding surface relative to the central axis of the upper die.

3. The apparatus for manufacturing a glass molding of claim 1,
wherein a dimension of the third molding surface in a direction of the central axis, and a dimension of a side surface of the glass molding in the direction of the central axis meet a following conditional expression (2), the side surface including a transfer surface formed by the third molding surface:
0.1<d/D<0.7 (2)
wherein
d: The dimension of the third molding surface in the direction of the central axis
D: The dimension of the side surface of the glass molding in the direction of the central axis, the side surface including the transfer surface formed by the third molding surface.

4. A method for manufacturing a glass molding by using a lower die and an upper die, the method comprising the steps of:
supplying molten glass to the lower die; and
conducting pressure-molding of the molten glass by the upper die and the lower die,
wherein the upper die comprises:
a first molding surface which transfers an optical surface;
a second molding surface which is flat and provided on a periphery of the first molding surface; and
a third molding surface which is provided on a periphery of the second molding surface and tilts relative to a central axis of the upper die, which passes through a center of the first molding surface so that the third molding surface spreads in a direction toward the lower die.

5. The method of claim 4,
wherein a tilt angle of the third molding surface relative to the central axis meets a following conditional expression (1):
10°<θ<60° (1)
wherein
θ: The tilt angle of the third molding surface relative to the central axis of the upper die.

6. The method of claim 4,
wherein a dimension of the third molding surface in a direction of the central axis, and a dimension of a side surface of the glass molding in the direction of the central axis meet a following conditional expression (2), the side surface including a transfer surface formed by the third molding surface:
0.1<d/D<0.7 (2)
wherein
d: The dimension of the third molding surface in the direction of the central axis
D: The dimension of the side surface of the glass molding in the direction of the central axis, the side surface including the transfer surface formed by the third molding surface.
